(19) United States
(12) Patent Application Publication
(10) Pub. No.: US 2004/0156763 A1
(43) Pub. Date: Aug. 12, 2004

(54) Reactor apparatus and mixing inlet and methods

(76) Inventors: Mark D. Wood, Wolverhampton (GB); Andrew J. Green, Northants (GB)

Correspondence Address: ALIX YALE & RISTAS LLP, 750 MAIN STREET, SUITE 1400, HARTFORD, CT, 06103, US

(21) Appl. No.: 10/471,466

(22) PCT Filed: Mar. 12, 2002
(86) PCT No.: PCT/GB02/01127

(30) Foreign Application Priority Data
Mar. 12, 2001 (GB) 0106057.3
Mar. 12, 2001 (GB) 0101058.1
May 4, 2001 (GB) 0111029.5

(51) Int. Cl. B01J 10/00

(52) U.S. Cl. 422/196; 422/198; 422/224

(57) ABSTRACT

The invention relates to reactor apparatus (1) comprising an assembly of a plurality of separate conduits (2) disposed within a vessel (3) for heat exchange between the conduits (2) and a medium (not shown) in the vessel (3), the separate conduits (2) being connectible to define one or more flow paths through the reactor (1), the length of the or each flow path being variable by adjusting the number of conduits connected such that the residence tine of reactants flowing in the or each flow path can be varied, and a mixing inlet (100) for mixing fluids comprising a conduit (200) adapted to be inserted into a fluid flow device (300) and means (400) disposed about the outer surface (700) of the conduit (200) to create turbulence in fluid in the device (300), there being at least one aperture (600) in the conduit (200) for addition and an additive, the turbulence causing mixing of the additive into the fluid show. Such a mixing inlet (100) can be used with reactor apparatus as described above.

This invention relates to reactor apparatus and a method for reacting fluids, and a mixing inlet and a method incorporating the use of such a mixing inlet.

In many industries, such as for example the chemical and pharmaceutical industries, reactions between fluids are carried out on a large scale, either by batch process or by continuous processing. Batch process equipment is flexible, but can be inefficient. An alternative to batch is continuous processing but this employs reaction-specific equipment which is inflexible and expensive to modify. One particular type of chemical reactor in which two fluids are reacted by mixing and heating and/or cooling by heat exchange is known. Such reactors normally consist of an outer shell having an inlet and an outlet for heat exchange medium, and disposed within the shell, a reaction chamber such as a sinuous pipe through which reactants pass into and out of the shell. The interiors of the shell and of the reaction chamber remain separate. In use, reactants are passed into the reaction chamber and the heating or cooling medium is passed into the shell as appropriate. As an example of the general problems referred to above, a particular problem with such devices is that the range of operating conditions and residence times is limited. Therefore, the specific set-up can accommodate only a narrow range of chemical reactions or chemical process conditions.

There is also a need in many industries, such as the chemical and pharmaceutical industries for a device and method for adding fluids to apparatus, in which the fluids are mixed as they are added, to achieve a chemical reaction or initial mixing prior to further processing downstream.

In the field of mixing fluids, static mixing devices, which can generally be described as conduits including in the flow path elements to cause turbulence in the fluid, are well known. For the most part attempts to improve these devices have centred on varying the configuration and disposition of the mixing elements within the conduit. Generally, fluids to be mixed are fed into the mixer separately, there being a bulk flow feed for the main constituent, and an additive feed. The additive feed is usually via a T-piece into the bulk feed upstream from the mixing elements, or into the mixing elements from the side.

Having the feed pipe approach the bulk flow tube perpendicularly is straightforward for operations when there are single in-line mixers. A problem arises where a number of tubes are contained in a bundle and it is desirable to add into any particular tube in the bundle, e.g. it would not always be possible to have a perpendicular T-mixer onto a tube in the centre of the bundle. The most desirable approach will be to have the feed pipe assembly in-line with the bulk flow so connections can be placed at the beginning of any desired tube. However, the position before the first element where the feed is added would be a region of low turbulence. It is desirable to make the addition in a region of high turbulence to improve initial dispersion of the additive.

Furthermore, a flexible reactor would have the ability to mix a range of different flow ratios—from 50:50 right down to 3000:1 or higher. One criterion for design is that the velocity of the additive stream must be equal to, or greater to a small extent, than the bulk flow. This will ensure good mixing of the additive in the feed pipe region and ensure that there is no back mixing into the feed pipe, which could affect the reaction. To achieve flexibility, the nozzle size of the feed pipe would have to be changed for each scenario, with smaller nozzles increasing the velocity of the additive for a given flow rate.

For operation utilising a common T-mixer for feed addition, if the flow rates are approximately equal, the level of turbulence will double between the upstream and downstream sections of the static mixer from the feed pipe. The initial feed will therefore be into a region of low turbulence, and the sudden change to high turbulence will produce non uniformity of mixing.

Increasing the number of feed pipes will decrease the mixing time scales of the bulk and additive fluids, as there is then less additive in any particular location. This has previously been achieved in the past by having two or more T-mixers entering the main tube in the same axial location along a static mixer through which the bulk fluid is flowing.

This would not normally be feasible if the tubes to be added to were in the middle of a bundle.

It is an object of the present invention to provide a new reactor apparatus and mixing inlet which address the problems above stated.

According to the invention there is provided reactor apparatus, comprising an assembly of a plurality of separate conduits, the separate conduits being connectible to define one or more flow paths through the reactor, the length of the or each flow path being variable by adjusting the number of conduits connected such that the residence time of reactants flowing in the or each flow path can be varied.

Thus, a wide range of chemical reactions can be operated and flow patterns of different lengths and configurations can be made, allowing different residence times to be achieved. Furthermore, processes can be run in series by adding different feeds sequentially and processes can be run in parallel for processes that do not require all of the conduits, increasing production rate.

The conduits may be connectible in fluid communication via connectors. The connectors may comprise U-bends, substantially solid bodies including flow paths, and flexible hoses, or any combination thereof. One or more connector may have a flow path with a cross-sectional area smaller than the cross-sectional area of the flow path in the conduits.

The provision of connectors enables easy reconfigurability of the apparatus and, if used, the reduced cross-sectional area of the flow path in the connectors increases turbulence which compensates for the lack of static mixing in the connectors. The reduced cross-sectional area also enables the conduits to be placed together to best utilise space and improve the heat transfer performance of the apparatus. Static mixer means may however be provided in the connectors.

In order to aid in mixing of reactants the conduits may include static mixer means therein.

The assembly of conduits may be disposed within a vessel adapted for heat exchange between the conduits and a medium in the vessel.

In this instance it is preferred that the apparatus includes means disposed within the vessel to create turbulence in the medium flowing therein. In particular, the turbulence creating means may comprise one or more baffle, or static mixer element. In this application, a static mixer element is understood to be a means to create appropriate levels of turbulence and/or mixing in the flowing medium.

In a preferred embodiment the or each flow path in the apparatus may include one or more inlet comprising a tube dimensioned to fit within a conduit, there being static mixer means between the tube and conduit. The static mixer means may be provided on the outer surface of the tube, or on the inner surface of the conduit. It is preferred that the or each inlet is demountable. The static mixer means may comprise for example strakes, baffles or other elements to induce the desired conditions.

According to a second aspect of the invention there is provided a method of facilitating a reaction process, comprising the step of providing the configuration of the connections of conduits and connectors within an apparatus as defined hereinabove according to the process requirements to provide a desired number of flow paths, and a desired residence time and level of mixing and heat transfer in each flow path.

The method may include the step of configuring the apparatus.

According to a third aspect of the invention there is provided the use of apparatus as hereinbefore defined for the performance of a reaction process.

According to a fourth aspect of the invention there is provided a kit of parts for providing reactor apparatus, the kit comprising a plurality of conduits and assembly means therefor, and connector means for connecting the conduits to define one or more flow paths through the reactor, the length of the or each flow path being variable by adjusting the number of conduits connected such that the residence time of reactants flowing in the or each flow path can be varied.

According to a further aspect of the invention there is provided a mixing inlet for mixing fluids comprising a conduit adapted to be inserted into a fluid flow device and means disposed about the outer surface of the conduit to create turbulence in fluid flowing in the device, there being at least one aperture in the conduit for addition of an additive to the flow, the turbulence causing mixing of the additive into the fluid flow.

It is preferred that the turbulence creating means comprises static mixer means. The static mixer means may be a feature of the surface of the conduit, or may be provided separately therefrom, for example as elements of the internal surface of a sleeve for insertion into the device to surround the conduit. As a further alternative, the static mixer means may be a feature of the flow device itself.

Each aperture may be disposed at or adjacent points of high bulk fluid velocity between the conduit and the device. In one embodiment of the invention there may be apertures of different diameters.

According to a further aspect of the invention there is provided a method of mixing a bulk flow fluid and a fluid additive comprising providing a mixer inlet as defined above, feeding the bulk flow fluid to the device, and feeding the additive to the conduit. The additive and/or the bulk fluid may be fed in under raised pressure.

The invention will further be described by way of example only and with reference to the accompanying drawings in which:

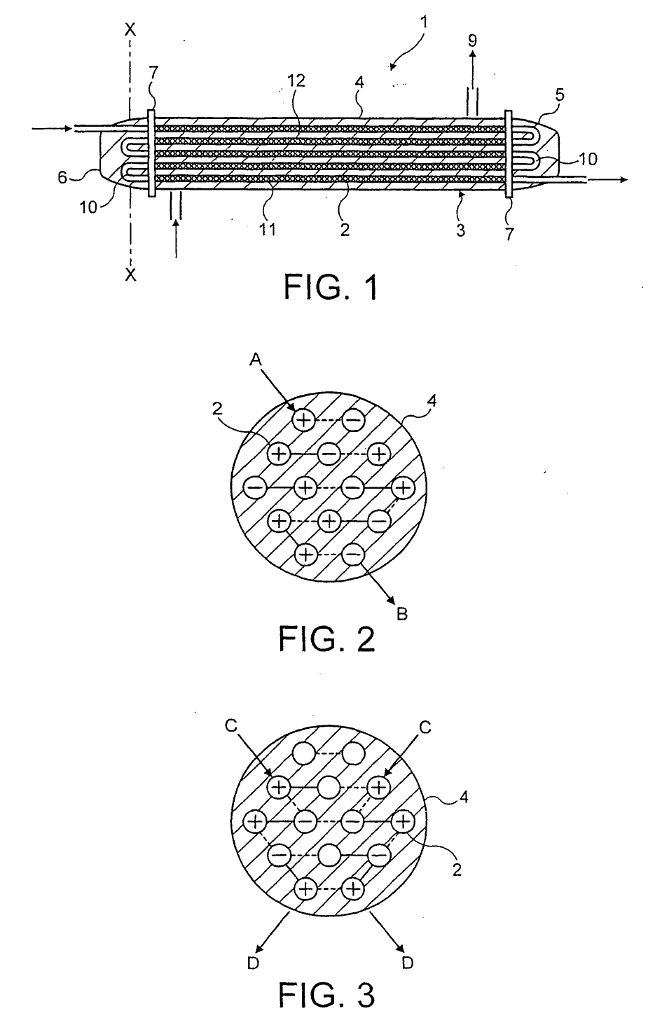

FIG. 1 is a schematic transverse sectional view through reactor apparatus according to the invention;

FIG. 2 is a schematic cross-sectional view through the apparatus of FIG. 1 in a first configuration;

FIG. 3 is a schematic cross-sectional view through the apparatus of FIG. 1 in a second configuration;

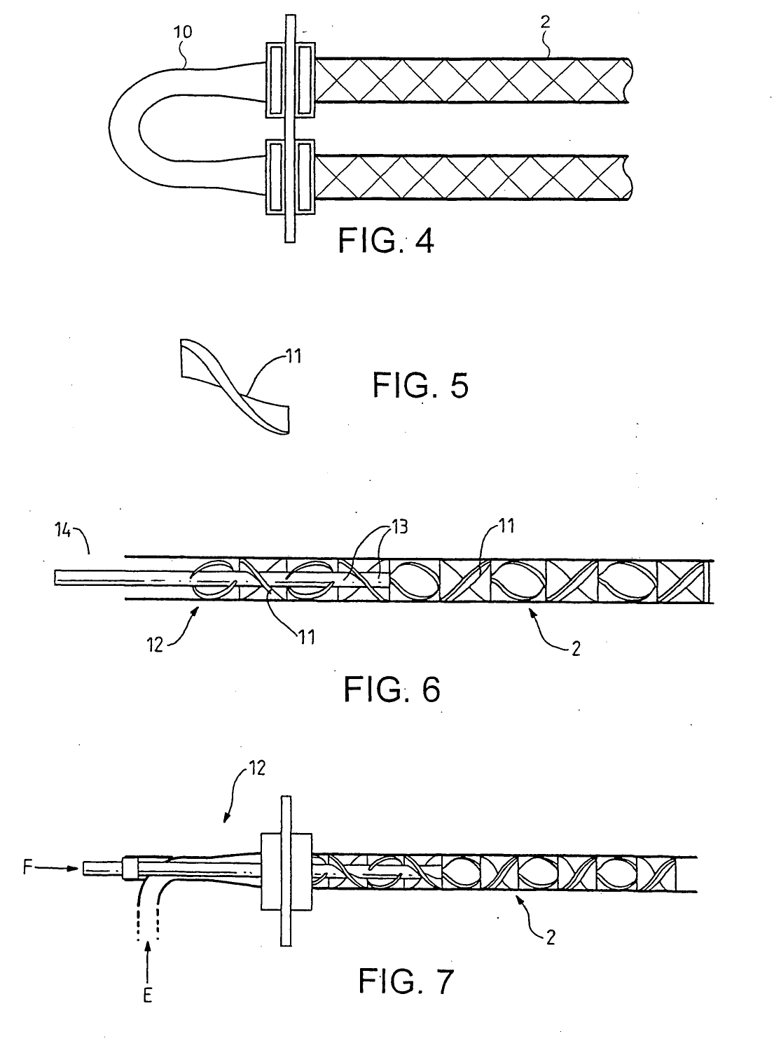

FIG. 4 is an enlarged schematic view of a part of the apparatus of FIG. 1;

FIG. 5 is a view of a static mixing element suitable for use in reactor apparatus according to the invention;

FIG. 6 is an enlarged view of a conduit in the apparatus of FIG. 1 with the embodiment of inlet mixer feed arrangement;

FIG. 7 is an enlarged schematic view of the inlet of the apparatus of FIG. 1.

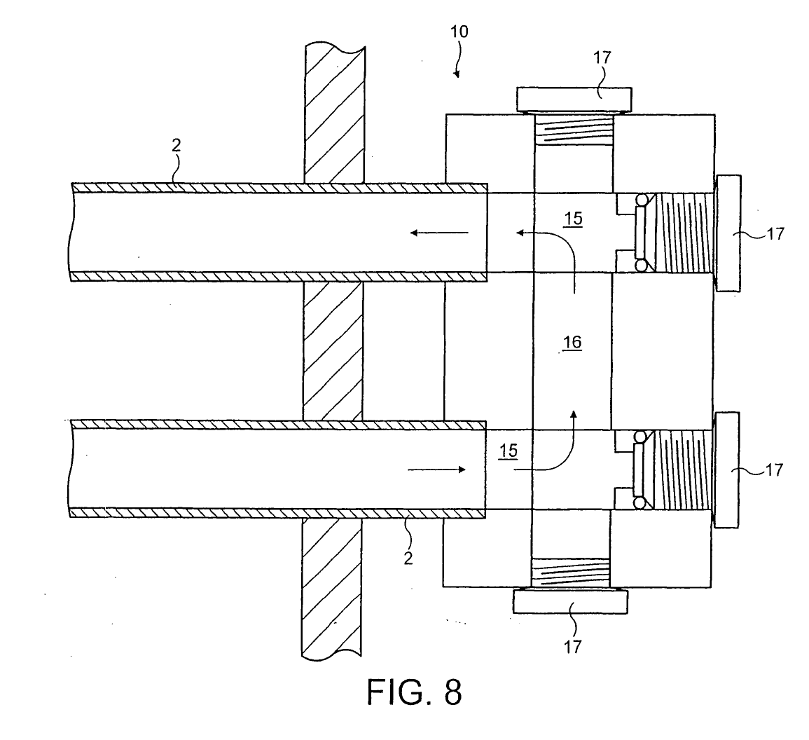

FIG. 8 is a transverse sectional view of an alternative form of connector for use with the apparatus of FIG. 1;

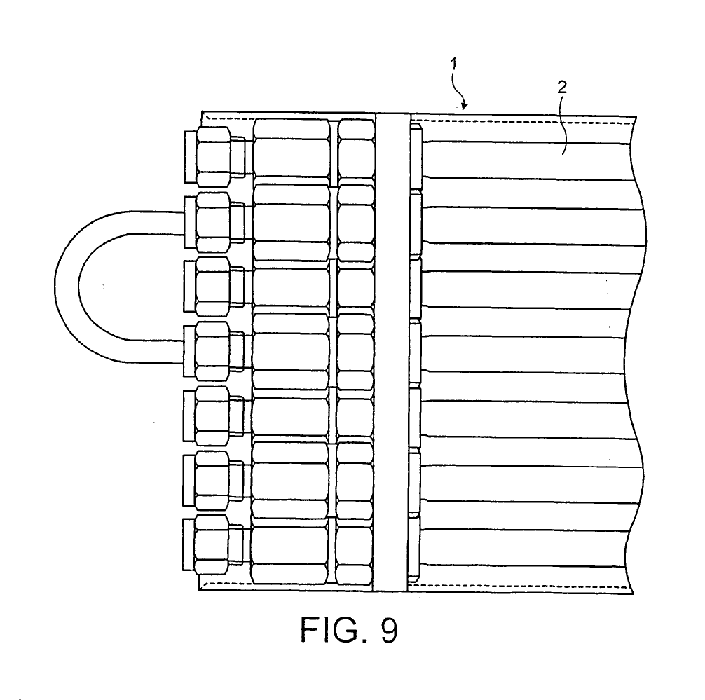

FIG. 9 is a plan view showing a part of an alternative reactor apparatus according to the invention;

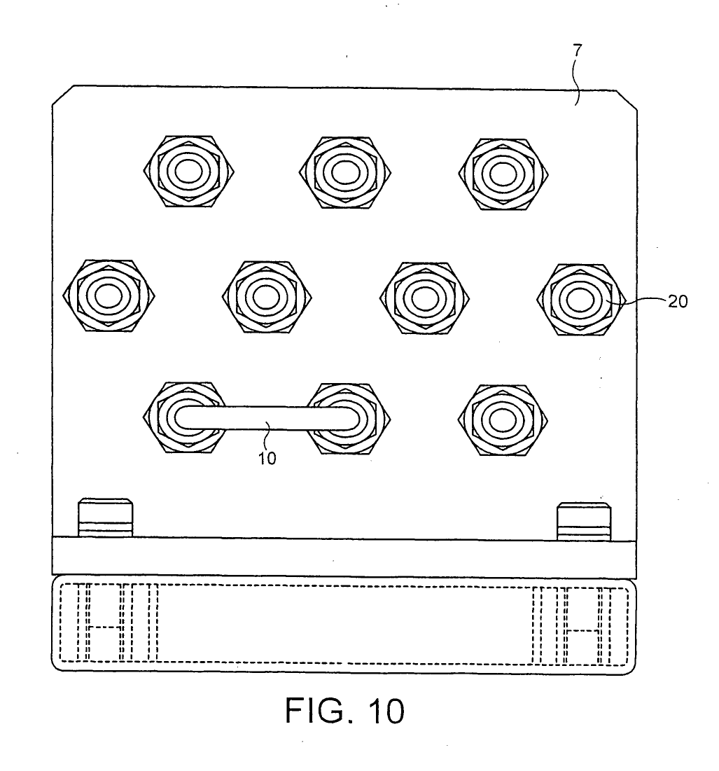

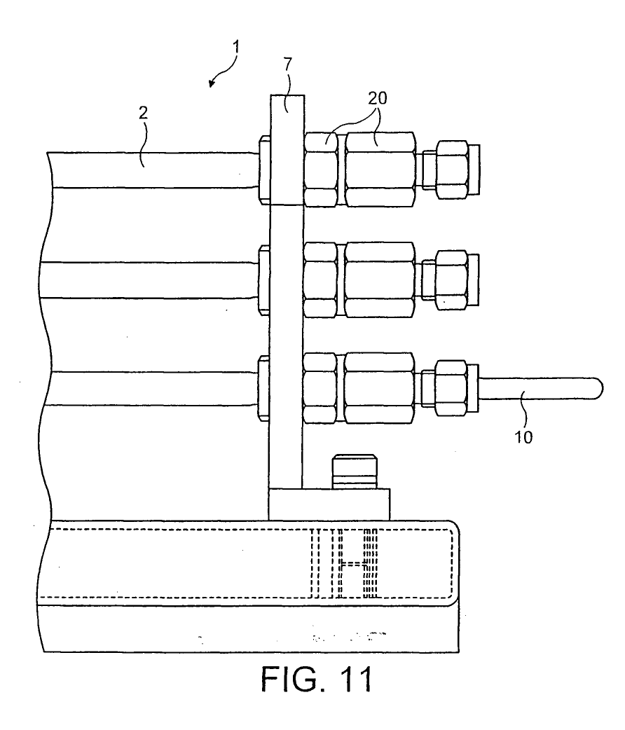

FIG. 10 is an end view of the apparatus of FIG. 9;

FIG. 11 is a side view showing a part of the apparatus of FIG. 9;

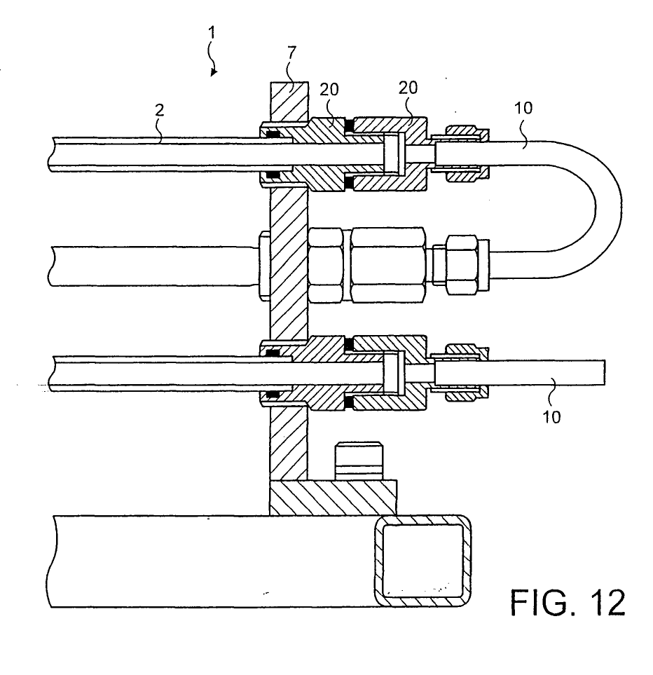

FIG. 12 is a transverse sectional view of the part of the apparatus of FIG. 9 shown in FIG. 11;

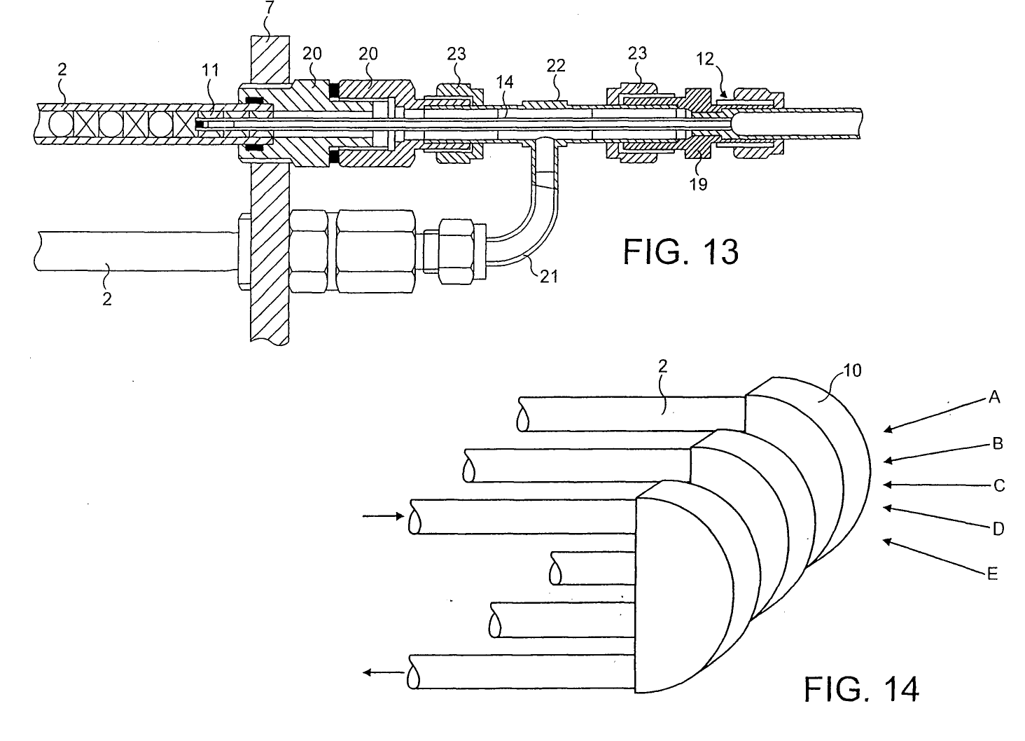

FIG. 13 is a part transverse sectional view of an inlet for use with the apparatus of FIG. 9;

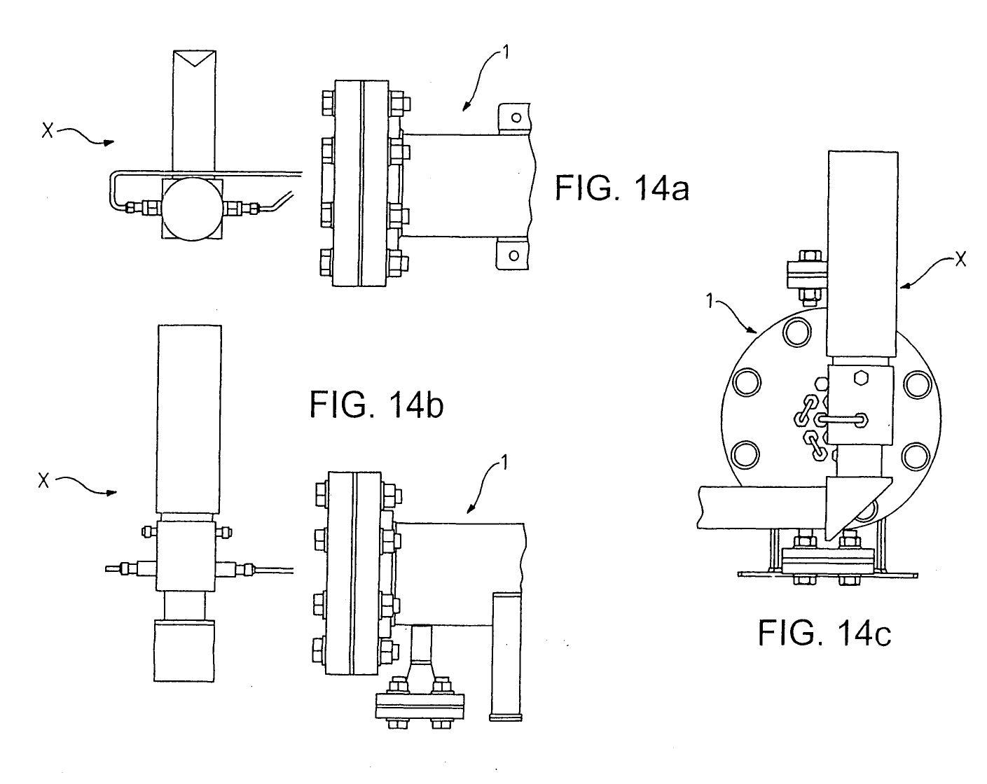

FIG. 14 is a schematic view of a part of reactor apparatus according to the invention.

FIGS. 14a to 14c are part views of a further embodiment of apparatus according to the invention;

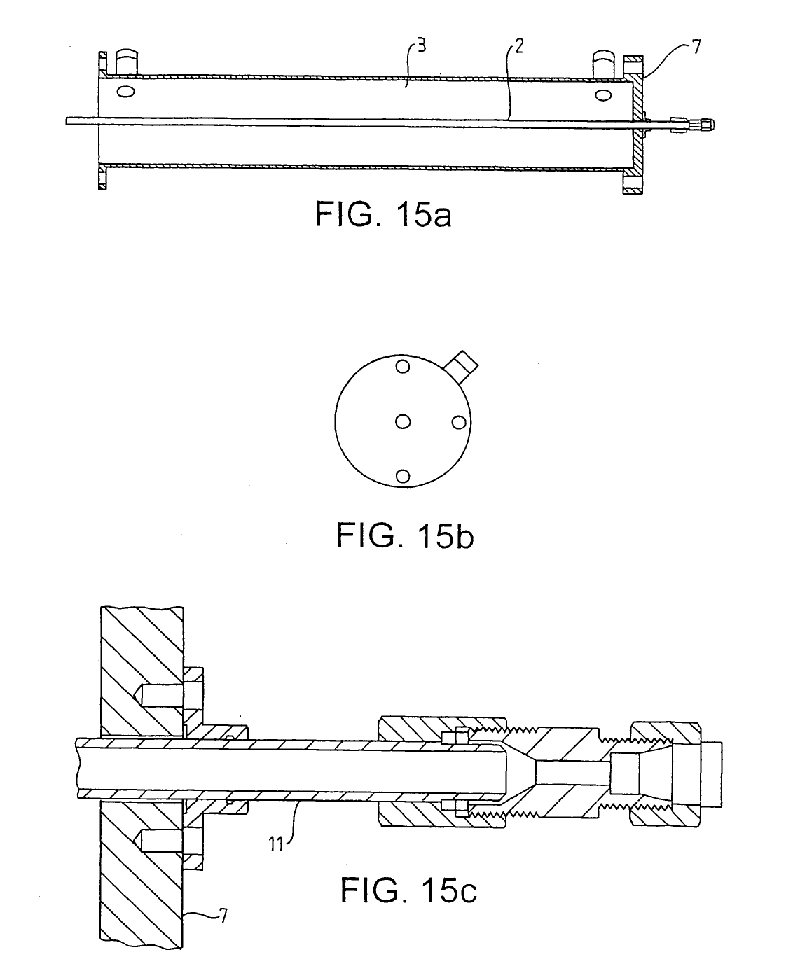

FIGS. 15a to 15c are views of a further reactor according to the invention;

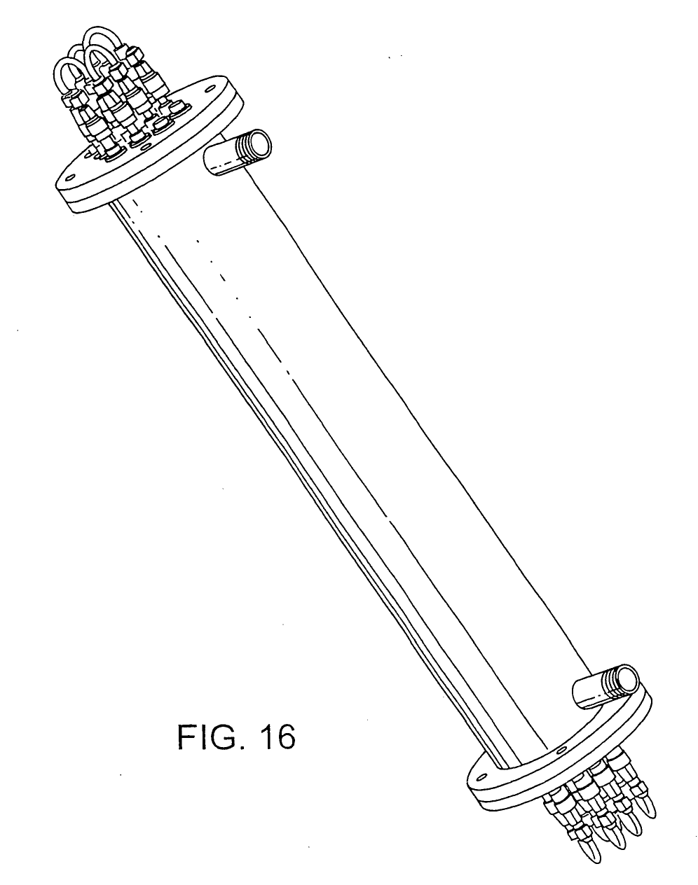

FIG. 16 is a perspective view of a further reactor according to the invention;

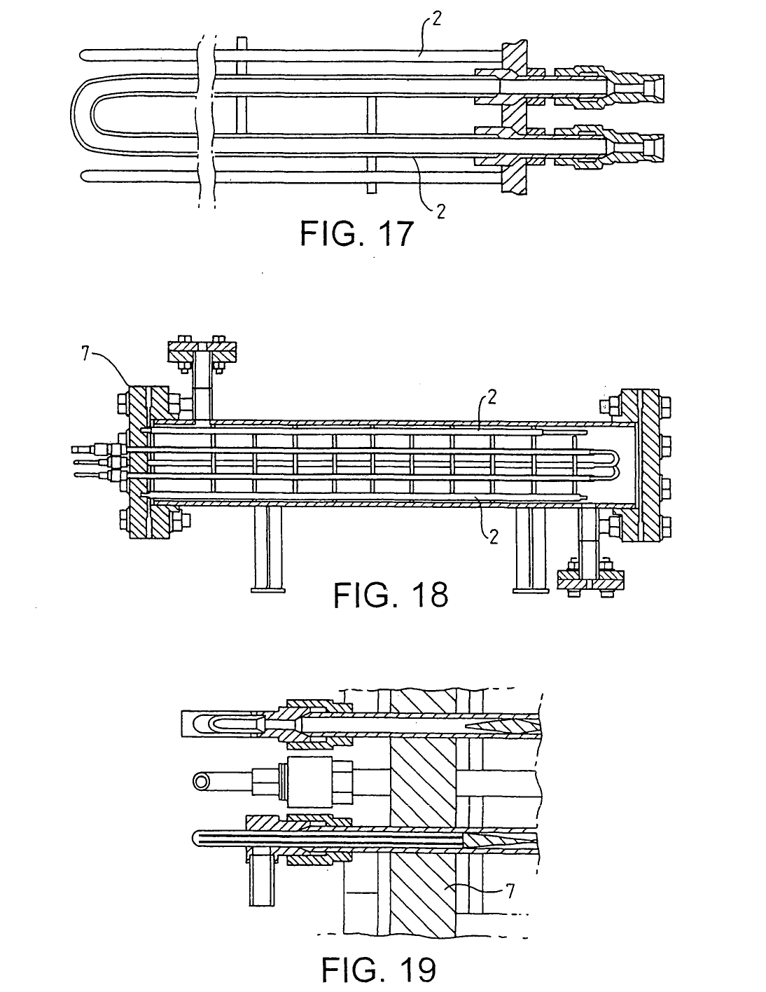

FIG. 17 is a transverse cross-sectional view of a further reactor according to the invention;

FIG. 18 is a transverse cross-sectional view of a further reactor according to the invention;

FIG. 19 is an enlarged, transverse sectional view of a part of FIG. 18;

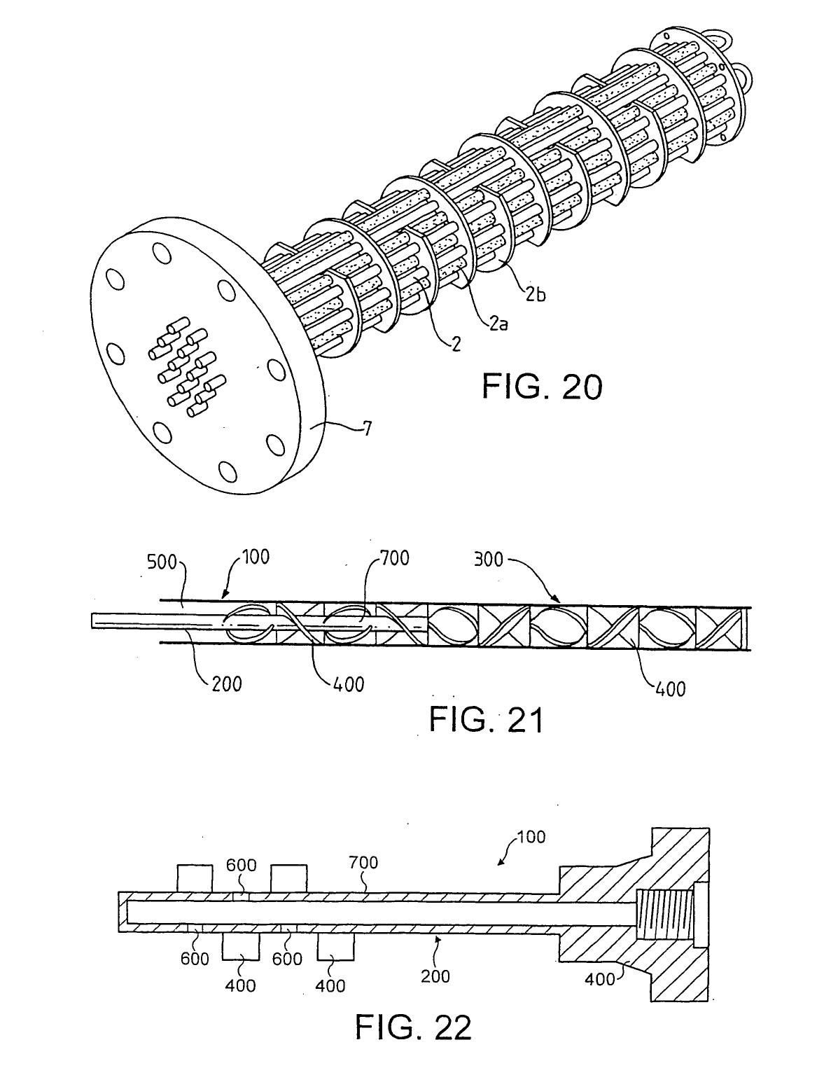

FIG. 20 is a perspective view of a further reactor according to the invention;

FIG. 21 is a transverse cross-sectional view of a first embodiment of mixing apparatus according to the invention;

FIG. 22 is a transverse cross-sectional view of a second embodiment of mixing apparatus according to the invention.

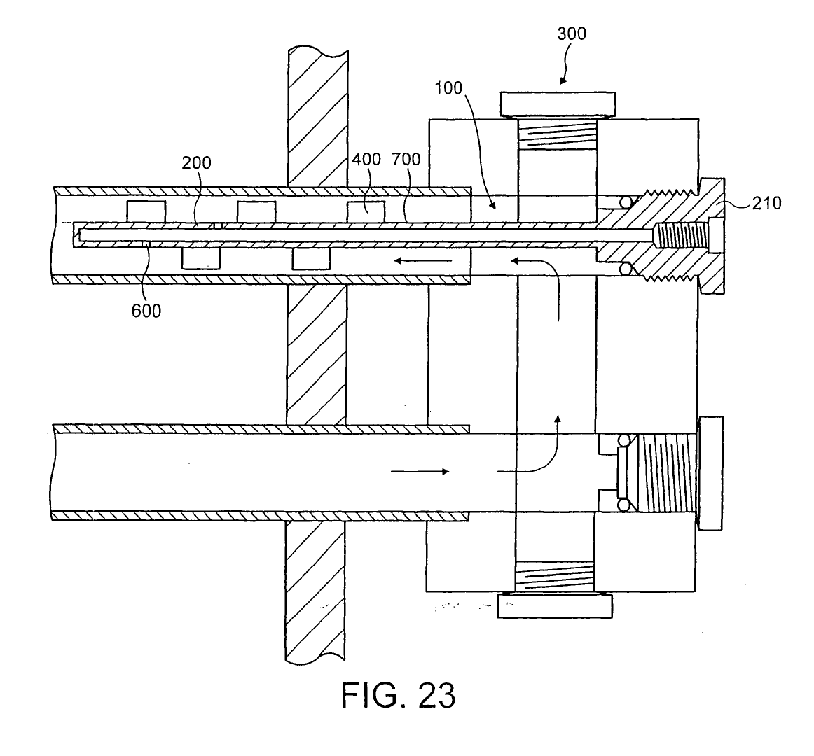

FIG. 23 is a transverse cross-sectional view of the mixer of FIG. 22 in the reactor of FIG. 8;

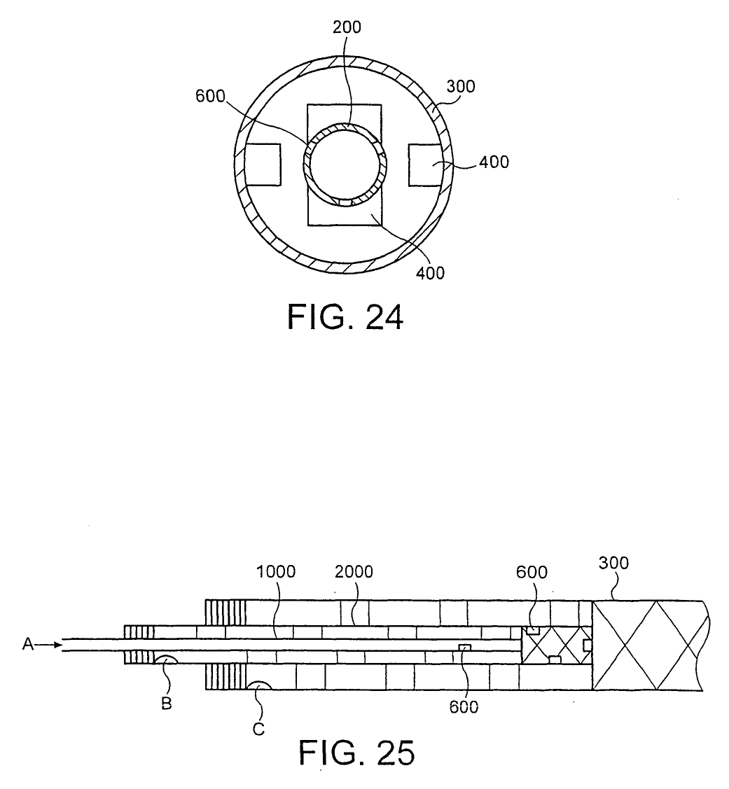

FIG. 24 is an end view of a further embodiment of mixing apparatus according to the invention;

FIG. 25 is a transverse sectional view of a still further embodiment of the invention;

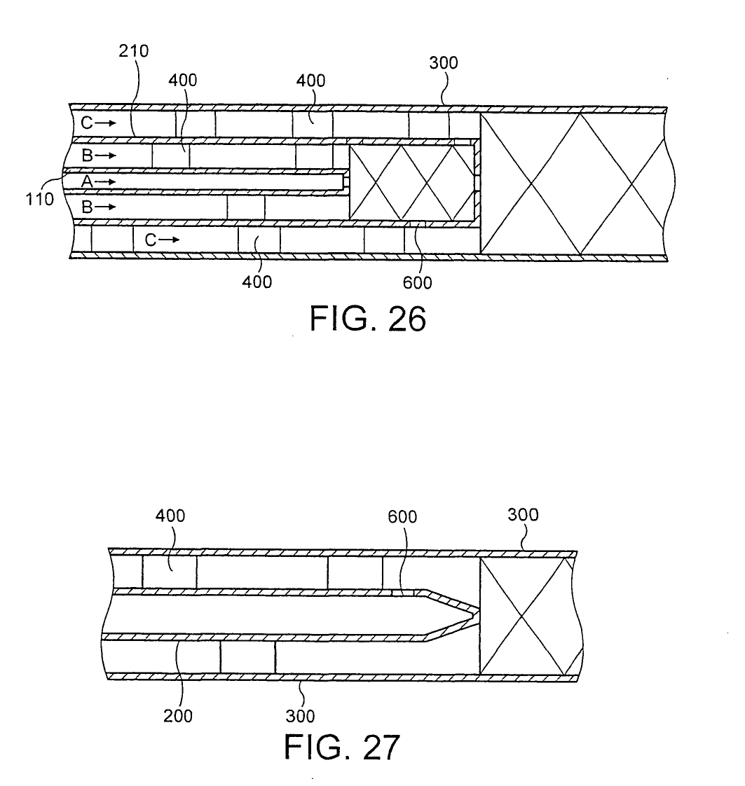

FIG. 26 is an enlarged view of a part of FIG. 25;

FIG. 27 is a part, transverse sectional view of a still further embodiment of the invention;

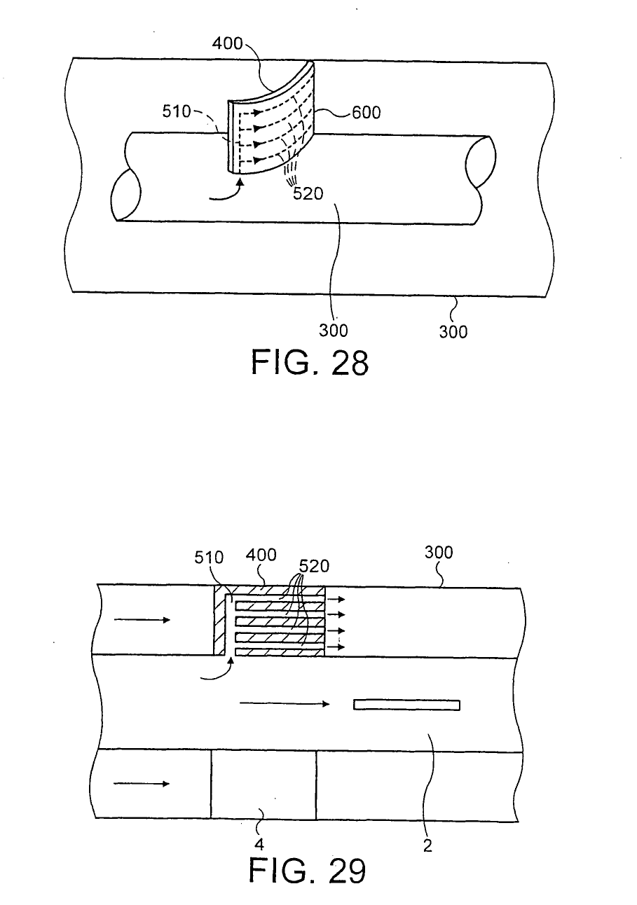

FIG. 28 is a part perspective view of apparatus according to a still further embodiment of the apparatus;

FIG. 29 is a transverse sectional view of the embodiment shown in FIG. 28;

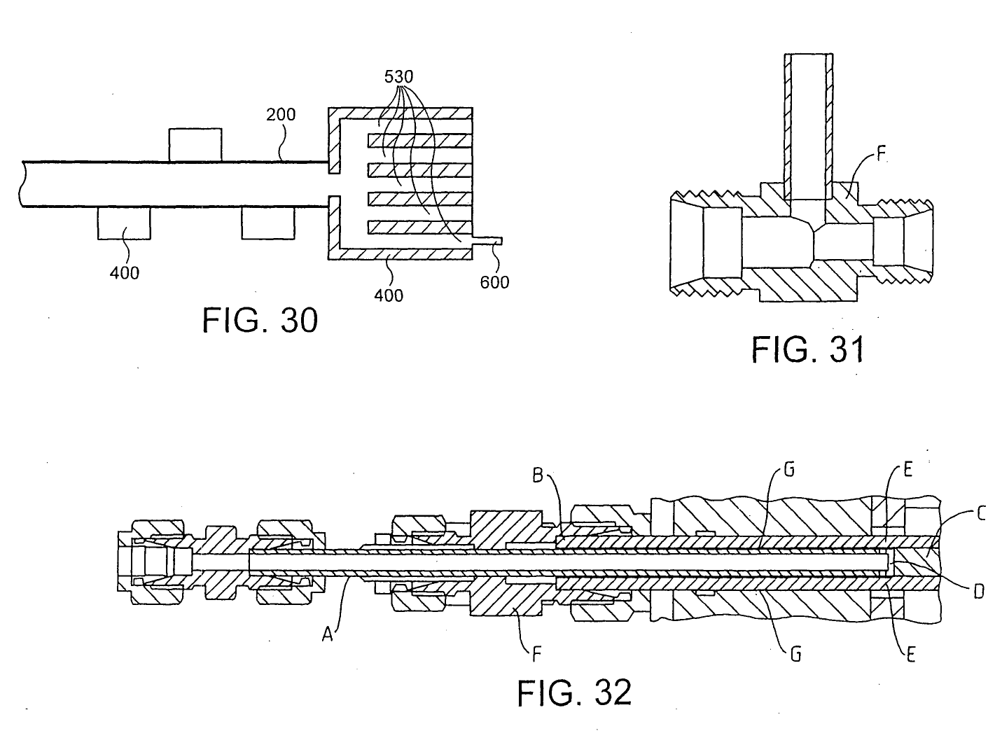

FIG. 30 is a transverse sectional view of a yet further embodiment of mixer of the invention;

FIG. 31 is a transverse sectional view of a yet further embodiment of mixer according to the invention; and

FIG. 32 is an enlarged view of part F of FIG. 31.

Referring to FIG. 1 of the drawings there is illustrated a first embodiment of reactor apparatus 1, comprising an assembly of a plurality of separate conduits 2 disposed within a vessel 3 for heat exchange between the conduits 2 and a medium (not shown) in the vessel 3, the separate conduits 2 being connectible to define one or more flow paths through the reactor 1, the length of the or each flow path being variable by adjusting the number of conduits connected such that the residence time of reactants flowing in the or each flow path can be varied.

As illustrated in FIG. 1 the vessel 3 comprises a generally cylindrical shell 4 having closed ends 5,6. Each end 5,6 may be removed from the shell 4 by means of a screw thread and seal arrangement (not shown) although any method of removable attachment, and which achieves a fluid tight seal if required, could be used. Between each end 5,6 and the shell 4 plates 7 are provided. The shell 4 includes an inlet 8 and an outlet 9.

A plurality of conduits 2 is disposed within the shell 4 the conduits being separate and extending the entire length of the shell 4. At each end, each conduit 2 is held in place in an aperture in a plate 7, the ends of each conduit 2 protruding a small distance through the plates 7. Adjacent conduits are connected in fluid communication by connectors 10, which in this embodiment are U-shaped tubes dimensioned and equipped to fit onto the conduit ends to provide a fluid tight connection as illustrated in FIG. 4. It will be noted that in this embodiment the cross-sectional area of the flow path in the connectors is smaller than the cross-sectional area of the flow path in the conduits 2.

As illustrated in FIG. 1, the conduits 2 are filled with static mixer elements 11 to aid mixing. The number and type of static mixer elements 11 required are determined as part of the design procedures when configuring the unit for a particular reaction scheme. Helical mixer elements are illustrated here. Baffles 12 are provided within the vessel 3 to increase turbulence of a fluid medium in the vessel 3 and improve the heat transfer.

As stated, the conduits 2 are joined by demountable and reconfigurable connectors 10 that contain a U-bend. These connectors 10 allow the conduits 2 to be configured in a number of ways providing variable flow patterns through the apparatus 1. For example, for fast reactions that require only a short residence time, the flow would only pass through one or two conduits 2. For slow reactions that require longer residence times, the flow can be made to pass through most or all of the conduits 2 in the apparatus 1. Examples of configurations are shown in FIGS. 2 and 3. Referring to FIG. 2, bulk flow enters at arrow A and exits at arrow B. A plus sign indicates flow into the plane of the page and a minus sign indicates flow out of the plane of the page. A solid line indicates that the connector is at the near end and a broken line indicates that the connector is at the far end. As will be appreciated, in this configuration all of the conduits 2 are utilised.

Referring to FIG. 3, which employs the same notation scheme as FIG. 2, bulk flow enters at arrows C and exits at arrows D, and thus this Figure illustrates a connector pattern for parallel processing.

As shown in detail in FIGS. 6 and 7, the apparatus 1 is provided with an inlet 12 to the flow path formed by the conduits 2 and connectors 10. Referring to FIG. 6, the inlet 12 comprises a tube 14 dimensioned to fit within conduit 2 substantially coaxially therewith, there being static mixer elements 11 disposed in the annulus between the tube 14 and the conduit and an outlet or outlets 13 adjacent the tube 14 end. As will be appreciated this inlet 12 enables a bulk flow fluid and an additive to be fed into the apparatus, and FIG. 7 illustrates how this is achieved. There may be more than one inlet, to allow for a staged feed of additive(s).

In use, bulk flow fluid is fed into the annulus between the tube 14 and conduit 2 with additive fluid being fed in via the bore of the tube 14. The static mixer elements 11 located in the annulus generate turbulence in the bulk fluid flow. The number of static mixer elements 11 in the annulus can be varied to ensure that turbulence is fully generated. Any number of outlets 13 can be made in the tube 14 for the additive feed to enter the bulk flow. The number, size and location of these feed outlets depends upon the flow rate and ratios of the particular system. The outlets will be located to discharge the addition feed into conduit 2 at the points where the best mixing is occurring. Points of high bulk fluid velocity, will occur in certain locations around the annulus static mixer elements 11 and will be suitable points for addition.

As will be appreciated, by having the bulk liquid flowing through an annulus, the velocity and level of turbulence is increased compared to flow through the full cross-section of a same diameter static mixer. Adjusting the relative diameters of the tube 14 and conduit 2 for different additive ratios will allow the turbulence to be balanced up and downstream of the addition point near and at the end of the tube 14.

Referring to FIG. 8, there is illustrated an alternative form of connector 10 and inlet 12. Here, instead of a U-bend the connector 10 takes the form of a solid block of, for example, stainless steel or other suitable material which is machined to provide axial flow paths 15 and transverse flow path 16 through the block. The block is attached to the ends of two conduits 2 to provide fluid communication therebetween, with plugs 17 fitted to close off apertures which are not in use.

Referring to FIGS. 9 to 12 there is illustrated a second embodiment of reactor apparatus 1, comprising an assembly of a plurality of separate conduits 2, the separate conduits 2 being connectible to define one or more flow path through the reactor 1, the length of the or each flow path being variable by adjusting the number of conduits 2 connected such that the residence time of reactants flowing in the or each flow path can be varied.

In this embodiment, there is no vessel 3 surrounding the assembly of conduits 2 for heat exchange, although in all other respects the apparatus 1 functions in a similar fashion to that of the first described embodiment. The assembly comprises (from the top down as viewed in FIG. 10) a three, four, three arrangement of parallel conduits 2 removeably mounted at both ends in plates 7 via couplings 20 which are adapted to receive suitably configured U-bends, or solid block connectors 10.

Referring to FIG. 13, there is illustrated another form of inlet 12 and connector 10. Here the connector takes the form of a pipe 21 connected to the leg of a T-piece 22 which has fittings 23 at the end of each arm of the “T”. The fittings 23 enable the T-piece to be connected to fitting 20 of the apparatus 1 and to inlet 12. Inlet 12 in this embodiment comprises tube 14 and head 19.

Referring to FIG. 14 there is illustrated a schematic of part of a reactor apparatus 1 according to the invention which demonstrates the possibility for putting A monitoring, B control, C sampling/online analysis, D extra heat exchange and E separation devices into the connectors 10. FIGS. 14a to 14c show a particular example of this, and illustrate the incorporation of a flow cell X for an infra-red monitoring probe. One of the U-bend connections 10 has been replaced by pipes which pass the flow through the flow cell for the probe.

As will be appreciated from the foregoing description, it is envisaged that reactors according to the invention may be provided with removable connectors 10 at one, or both ends of the reactor 1. FIGS. 15a to 15c and 16 illustrate a double ended design in which connectors 10 at both ends are removable/configurable. In this embodiment conduits 2 pass through the end plates 7 into the vessel for heat exchange 3 through a sealing arrangement (for example a gland incorporating two O rings). The connectors and U-bends are outside the heat exchange vessel. A cone and circlip joint can be used, which can be readily removed enabling the conduit 2 to be removed from the vessel (as it has no protrusions outside its diameter). The benefits of this design are:

It is highly flexible, with connectors at both ends of the heat exchange vessel allowing a very large range of configurations:

conduits can be readily removed, allowing easy replacement if alternative conduits are required (e.g. incorporating other mixing elements, alternative materials of construction, replacement if elements become blocked or corroded)

the joints between the conduits and connectors are outside the shell, so there is no risk of leakage between the process fluid and heat exchange fluid in the event of failure of the joint

the sealing arrangement allows for differential thermal expansion between the shell and the conduits.

FIGS. 17, 18 and 19 illustrate a single ended design. In this embodiment removable connectors 10 are only included at one end, with connectors at the other end welded or otherwise permanently secured to form a ‘hairpin’ configuration. The conduits 2 and baffles are secured to one end plate 7, with the whole bundle (conduits and baffles) being removable from the heat exchange vessel/shell. The permanently secured connectors are within the heat exchange vessel/shell, but the removable connectors are outside.

Two methods for securing the conduits 2 into the end plate 7 are possible. In the first, the conduits pass through the end plate 7 and are secured by welding or other means of fixing. In this version, conduits 2 can only be replaced by cutting and drilling out one or more ‘hairpins’. However, it means that standard compression fittings (e.g. ‘Swagelok’) can be used for the connectors. In the second the conduits are secured to the end plate 7 via a bespoke ‘double cone’ system (FIG. 18, with connectors attached using the ‘cone and circlip’ joint described above. This allows pairs of conduits to be readily replaced (as hairpins), but has the drawbacks of complexity and the presence of a cone seal between process fluid and heat transfer fluid.

The design has the following benefits:

robust, simple mechanical design, with ability to cope with differential thermal expansion between the conduits and the vessel;

flexible, allowing many configurations (but not as many as the double ended design);

all the reconfigurability is at one end of the reactor, aiding maintenance and simplifying installation (i.e. do not need access to both ends);

one set of connectors are within the heat transfer fluid, increasing heat transfer performance;

(welded conduit design only) no potential direct leakage paths through seals/connectors between the process and heat transfer fluids.

Flexibility in this design can be enhanced by including a multiplicity of conduits 2′ in the apparatus with different mixing elements within them (e.g. some fully filled with mixers (possibly of different designs), some partially filled and some empty). These different elements can then be configured to provide the required heat transfer, mixing profile and residence time.

It is also possible to ultilise removable connectors at the bottom of the ‘hairpin’ (i.e. inside the shell) to increase flexibility, if the potential of leakage between the process and heat transfer fluid is not perceived to be a major problem.

FIG. 20 illustrates a further embodiment of reactor according to the invention in which dummy tubes 2a have been inserted between the conduits 2 in conjunction with baffles 2b in order to still further enhance heat exchange. These work by increasing turbulence around the conduits 2. The illustration shows a configuration which utilises essentially one dummy tube 2a for each conduit 2. Dependent on conduit diameter, spacing and layout it is in principle possible to use any number or configuration of dummy tubes 2a to gain the required enhancement.

It will be clear to the skilled worker that the invention embodied in the forgoing examples provides an apparatus which is flexible, enabling a large number of reactions to be performed and is thus highly economical.

Referring to FIGS. 21 to 32 of the drawings and in particular FIG. 21, there is illustrated a mixing inlet 100 for mixing fluids comprising a conduit 200 adapted to be inserted into a fluid flow device 300 and means 400 disposed about the outer surface 700 of the conduit 200 to create turbulence in fluid flowing in the device 300, there being at least one aperture 600 in the conduit 200 for addition of an additive, the turbulence causing mixing of the additive into the fluid flow. Such a mixing inlet 100 can be used with reactor apparatus as described above.

The end of the conduit 200 within the flow device 300 is closed, but adjacent the closed end small apertures 600 are provided (see FIG. 22). Static mixer means 400 is provided in the form of helical-type mixer elements. These are disposed in the annulus 500 between the conduit 200 and flow device 300 and can conveniently be fixed to the outer surface 700 of the conduit 200. In this embodiment the inlet 100 is part of a fluid flow device 300 which includes static mixer elements 400 downstream from conduit 200.

In use, the main or bulk flow fluid is fed into the annulus 500 between the conduit 200 and flow device 300 by any suitable means, with additive fluid being fed in via the bore of the conduit 200. The static mixer elements 400 located in the annulus 500 generate turbulence in the bulk fluid flow and the number of static mixer elements 400 in the annulus can be varied according to the characteristics of the fluid to ensure that turbulence is fully generated. The apertures 600 or feed holes, feed the additive into the bulk flow, and the number, size and location of these feed holes depends upon the flow rate and ratios of the particular system. The holes will be located to discharge the addition feed into the flow device 300 at the points where the best mixing is occurring. Points of high bulk fluid velocity, will occur in certain locations around the annulus static mixer elements and are suitable points for addition.

As will be appreciated, by having the bulk liquid flowing through the annulus 500, the velocity and level of turbulence will be increased compared to the same flow through the full cross-section of a same diameter static mixer. Adjusting the relative diameters of the conduit 200 and device 300 for different additive ratios will allow the turbulence to be balanced up and downstream of the addition point near and at the end of the conduit 200.

Referring to FIG. 23, another form of inlet 100 is illustrated which comprises conduit 200 dimensioned to fit within the reactor apparatus illustrated in FIG. 8, in this case substantially coaxially therewith, there being static mixer elements 400 in the form of tabs on the outer surface 700 of the conduit 200. At its upstream (in use) end the conduit 200 has a head 210 dimensioned to fit via a screw-thread and seal arrangement into the reactor.

Referring to FIG. 24, an alternative embodiment of the invention is illustrated having static mixer elements 400 both on the outside of the conduit 200 and on the inside of flow device 300 which here is a bulk tube. The static mixer elements 4 act together to provide turbulence of a different flow pattern to that which would be achieved through having static mixer elements either on just the outside of the conduit 200, or just the inside of the flow device 300. The feed aperture 600 would be appropriately placed to ensure the feed is added into regions of high turbulence generated by the elements 400.

Referring to FIGS. 25 and 26, the concept of adding feed co-axially with the static mixers in the annulus can be extended to adding two, or more, feeds to the bulk fluid. Feed stream A flows down the inside of the feed pipe 1000, which is sited coaxially inside feed pipe 2000. Feed stream B flows down the annulus outside feed pipe 1000, and turbulence is generated by the static mixer elements in the annulus. The addition of feed stream A to feed stream B is through the feed apertures as previously described.

Static mixer elements are then provided across the full diameter of feed pipe 2000 after feed pipe 1000 has ended. These mixer elements continue for a specified length until full mixing has been achieved.

Feed pipe 2000 is situated inside the device 300, with bulk flow C in the annulus between the device 3 and feed pipe 20. Addition of the mixture of A and B takes place through feed apertures into the bulk flow C in the same manner as described above.

In this way, any number of feed additions could be made coaxially.

FIG. 26 shows an example of how the feed pipes and the flow device would be connected. Feed pipe 110 enters feed pipe 1210 coaxially through a fluid seal joint that can be detached. Feed pipe 210 containing feed pipe 110 then enters the device in the same manner. Feed A flows down the centre of feed pipe 110. Feed B enters feed pipe 210 immediately after the fluid seal joint and static mixer elements are used to ensure it is fully distributed over the exterior of feed pipe 110. Bulk flow C enters the device immediately after the fluid seal joint with feed pipe 210 and static mixer elements are used to ensure it is fully distributed over the exterior of feed pipe 210.

FIG. 27 shows a profiled conduit 200 where the end of the feed pipe tapers to a point. A feed aperture can be included at the very point in addition to those on the walls of the conduit. The profile on the feed pipe will benefit the overall mixing and flow patterns by ensuring that there is no dead spot immediately at the end of the conduit where mixing could otherwise be limited, especially with larger diameter conduits 200.

In some circumstances it is desirable to have the ability to change the size and/or location and/or number of apertures 600 provided by the inlet 100, and this can be accomplished most easily by substituting an appropriate conduit 200 in the inlet 100. Alternatively arrangements can be envisaged wherein the size of apertures 600 can be varied by the use of for example a sleeve inside conduit 200 with apertures that can be brought into register with apertures 600 of the conduit.

Referring to FIGS. 28 to 30, an arrangement that is beneficial for adding and mixing fluids with high viscosities and/or significant viscosity differences will now be described. In these circumstances it is preferable to have a large number of small feed apertures, as if the feed apertures were relatively large, there may be the tendency for globules of feed to form that impede mixing with the bulk liquid. It will also be beneficial to distribute the additive across the full radius of the bulk flow pipe.

This arrangement of the mixer inlet to meet the above requirements consists of apertures for the feed additive being incorporated within the static mixer elements.

Referring to FIG. 28, the static mixer element 400 consists of a blade attached to the conduit 200 where the conduit 200 substantially runs coaxially with the bulk flow. Additive flows down the centre of the conduit 200. Specific static mixer elements 400 have passageways 510, 520 incorporated within them enabling additive to flow through the static mixer element 400 and exit through apertures 600 into the bulk flow.

The passageways 510, 520 could be constructed by manufacturing the mixer element 400 in two halves with half of the passageway etched onto each surface. The elements 4 could then be fixed together, e.g. by diffusion bonding, to create the full, open passageway.

FIGS. 28 and 29 show a main passageway 510 running the full height of the static mixer element 400 in a direction that is generally perpendicular to the bulk flow in the device. From this main passageway, any number of sub-passageways 520 can then be taken off in a direction generally parallel to the bulk flow. The additive is then distributed through apertures 600 at the trailing edge of the static mixer element 400. The location of the apertures 600 will depend upon the particular system being operated. The invention will allow the apertures to be located at any point on the surface of the static mixer elements.

The particular benefit of this arrangement is that additive is added to the bulk flow at the points of high turbulence and can be added across the full radius of the bulk pipe. The large number of feed apertures 600 also reduces the mixing time scales by reducing the quantity of feed present in a particular location.

Referring to FIG. 30 a further alternative configuration is shown, wherein the end of conduit 200 is formed to provide a plurality of separate passages 530 leading from the bore of the conduit 200 to apertures 600.

Referring to FIGS. 31 and 32, a still further configuration of inlet according to the invention is shown. It comprises an additive flow inlet conduit (marked A), which is inserted into the mixing conduit (B), up to the start of the mixing element (c). The inlet is sealed at the end (D) with one or more outlet holes for the secondary flow (E), which may be in the pipe or the sealed end. The number, size and orientation of the holes will be designed according to the ratio of flows between bulk and additive. Bulk flow enters at right angles to the additive flow in a T-piece (F—bulk flow entry is out of paper, so not shown in the Figure), then travels along the annulus between the additive flow conduit and the mixing conduit (G—shown black in the figure—not to scale). By flowing through the annulus turbulence will be enhanced leading to good mixing when the additive flow is injected into the bulk flow at point E, although if required this can be enhanced further by the introduction of strakes, baffles etc as per the other embodiments. Bulk flow inlet can either be from the bulk feed to the reactor (for initial injection) or from the outlet of one of the other conduits (for intermediate feeding).

Apparatus as described herein provides the benefit that a higher degree of turbulence for a given flow rate can be achieved than in a full width static mixer of the same outer diameter. Furthermore, addition can be made directly into regions of high turbulence and addition is in-line, without the need for perpendicular T-junctions. This allows addition to downstream apparatus where space is limited, such as delivery to a flow device or devices in the centre of a bundle. A range of flow addition ratios can be achieved through the use of different numbers of differently sized and located holes 6.

1. Reactor apparatus, comprising an assembly of a plurality of separate conduits, the separate conduits being connectible to define one or more flow paths, the length of the or each flow path being variable by adjusting the number of conduits connected such that the residence time of reactants flowing in the or each flow path can be variable.

2. Apparatus according to claim 1, the conduits being connectable in fluid communication via connectors.

3. Apparatus according to claim 2, one or more connector comprising a U-bend.

4. Apparatus according to claim 2, one or more connector comprising a substantially solid body including a flow path therein.

5. Apparatus according to claim 2, one or more connector comprising a flexible hose.

6. Apparatus according to any of claims 2 to 5, one or more connector having a flow path with a cross-sectional area smaller than the cross-sectional area of the flow path in the conduits.

7. Apparatus according to any of claims 2 to 6, one or more connector including static mixer means.

8. Apparatus according to any preceding claim, the conduits including static mixer means therein.

9. Apparatus according to any preceding claim, the assembly of conduits being disposed within a vessel adapted for heat exchange between the conduits and a medium in the vessel.

10. Apparatus according to claim 9, including means disposed within the vessel to enhance heat transfer between the conduits and medium flowing in the vessel.

11. Apparatus according to claim 10, the enhanced heat transfer creating means comprising one or more baffle.

12. Apparatus according to any preceding claim, the or each flow path including one or more inlet comprising a tube dimensioned to fit within a conduit, there being static mixer means between the tube and conduit.

13. Apparatus according to claim 12, the or each inlet being demountable.

14. Apparatus according to any of claims 7 to 13, the static mixer means comprising strakes and/or baffles.

15. Reactor apparatus, substantially as hereinbefore described with reference to the accompanying drawings.

16. A method of facilitating a reaction process, comprising the step of providing the configuration of the connections of conduits and connectors within an apparatus according to any of claims 1 to 15 according to the process requirements to provide a desired number of flow paths, and a desired residence time, mixing and heat transfer in each flow path.

17. A method according to claim 16, including the step of configuring the apparatus.

18. The use of apparatus according to any of claims 1 to 15 for the performance of a reaction process.

19. A kit of parts for providing a reactor apparatus, the kit comprising a plurality of conduits and assembly means therefor, and connector means for connecting the conduits to define one or more flow paths through the reactor, the length of the or each flow path being variable by adjusting the number of conduits connected such that the residence time, mixing and heat transfer of reactants flowing in the or each flow path can be varied.

20. A mixing inlet for mixing fluids, comprising a conduit adapted to be inserted into a fluid flow device, and means disposed about the outer surface of the conduit to create turbulence in fluid flowing in the device, there being at least one flow aperture for addition of an additive from the conduit, the turbulence causing mixing of the additive into the fluid flow.

21. An inlet according to claim 20, the turbulence creating means comprising static mixer means.

22. An inlet according to claim 21, the static mixer means being a feature of the surface of the conduit.

23. An inlet according to claim 21, the static mixer means comprising elements of the internal surface of a sleeve adapted for insertion into the device to surround the conduit.

24. An inlet according to any of claims 21 to 23, the static mixer means being a feature of the device.

25. An inlet according to claim 21, the static mixer means being a combination of one or more features of the surface of the conduit and/or one or more element of the internal surface of a sleeve adapted for insertion into the device to surround the conduit, and/or a feature of the device.

26. An inlet according to any preceding claim, the end of the conduit for insertion in the device being profiled.

27. An inlet according to any preceding claim, each flow aperture being disposed at or adjacent points of high bulk fluid velocity in the annulus between the conduits.

28. An inlet according to any of claims 21 to 27, the or each flow aperture being in the static mixer means.

29. An inlet according to any preceding claim, including apertures of different diameters.

30. An inlet according to any preceding claim, including a plurality of coaxial conduits, each conduit comprising means disposed about its outer surface to create turbulence in fluid flowing there past.

31. An inlet, substantially as hereinbefore described with reference to the accompanying drawings.

32. A method of mixing a bulk flow fluid and a fluid additive comprising providing a mixer inlet as defined in any of claims 20 to 31, feeding the bulk flow fluid to the device, and feeding the additive to the inlet.

33. A method according to claim 32, wherein the additive and/or the bulk fluid is fed in under raised pressure.
